(19) United States
(12) Patent Application Publication
(10) Pub. No.: US 2008/0231066 A1
(43) Pub. Date: Sep. 25, 2008

(54) Flatbed tool drawers

(76) Inventor: Terry Harrell, Preston, GA (US)

Correspondence Address: Charles Peeler, P.O. Box 7, Albany, GA, 31702, US

(21) Appl. No.: 11/982,638

(22) Filed: Nov. 2, 2007

Related U.S. Application Data
(60) Provisional application No. 60/856,367, filed on Nov. 3, 2006.

(51) Int. Cl. B60R 9/00

(52) U.S. Cl. 296/37.6

(57) ABSTRACT

The present invention is a flatbed tool drawer system for mounting on a flatbed truck. The system of the present invention includes a rectangular flatbed surface, protective guard extending vertically upward from the front of the flatbed surface, a compartment assembly extending vertically downward from the rear of the flatbed surface and a second and a third compartment assembly extending vertically downward from opposing sides of the flatbed surface.

### RELATED APPLICATION

This application claims priority to provisional patent application No. 60/856,367 entitled Flatbed Tool Drawers filed Nov. 3, 2006 in the name of Terry Harrell, Preston, Ga.

### FIELD OF THE INVENTION

The field of the present invention relates to a tool drawer system for a flatbed truck.

### BACKGROUND OF THE INVENTION

The present invention is generally related to a storage system comprised of a plurality of drawers and storage containers for storing tools on a flatbed truck. The drawers are generally of a slide out nature. Prior arts systems have attempted to address the problem of carrying, in a compartmentalized fashion, tools on vehicles such as pick up trucks. The object of the present invention is to set forth a novel flatbed truck storage system which may be universally used with new and existing flatbed trucks. A flatbed truck differs from a pickup truck in that a flatbed truck bed is comprised of a flat horizontal platform or pad, but unlike a traditional pickup truck a flatbed truck does not have vertical walls surrounding the four sides of the truck bed. Storage of tools on a flatbed truck is challenging in that unlike a traditional pickup truck, the nature of the flatbed is such that a traditional tool box will slide off of a flatbed because there are no walls to hold the toolbox. In addition, traditional tool storage systems for pickup trucks take up room in the cargo bed area thereby reducing the amount of cargo that the truck can carry.

What is needed in the art is a mobile toolbox comprised of a plurality of drawers and storage compartments for carrying a tool collection on a flatbed truck without diminishing the amount of cargo that may be carried on the flatbed.

During the course of preparing this specification for submission to the United States Patent Office, the following patents were identified as related, yet distinguishable, from the instant invention:
U.S. Pat. No. 5,685,593 discloses a molded combination storage unit and truck bed liner. The storage unit and truck bed liner fits in the bed compartment of a traditional pickup truck comprised of a bed and surrounding walls. It does not disclose drawers and storage compartments that extend away from and are accessible from three sides of the truck flatbed without reducing the amount of cargo that may be carried on a flatbed.
U.S. Pat. No. 6,283,526 discloses a storage unit for a pickup truck bed. The storage unit fits in the bed compartment of a traditional pickup truck comprised of a bed and surrounding walls. It does not disclose drawers and storage compartments that extend away from and are accessible from three sides of the truck flatbed without reducing the amount of cargo that may be carried on a flatbed.
U.S. Pat. No. 5,848,818 also discloses a storage unit for a pickup truck bed. The storage unit fits in a portion of the bed compartment of a traditional pickup truck comprised of a bed and surrounding walls. It does not disclose drawers and storage compartments that extend away from and are accessible from three sides of the truck flatbed without reducing the amount of cargo that may be carried on a flatbed.
U.S. Pat. No. 4,733,898 discloses a storage device fitting in the floor of a pickup truck bed. The storage device also comprises drawers extending from the rear of a traditional pickup truck. It does not disclose drawers and storage compartments that extend away from and are accessible from three sides of the truck flatbed without reducing the amount of cargo that may be carried on a flatbed.

### SUMMARY OF THE INVENTION

The present invention relates to a flatbed tool drawer system comprising a rectangular flatbed surface extending horizontally from behind the cab of a flatbed truck. The invention further includes a protective guard extending vertically upward from the front of the flatbed surface providing protection to the rear window and rear surface of the truck cab. The invention further comprises tool storage drawers horizontally extendable away from the truck. The drawers extend from beneath the flatbed surface on three sides (left, right and rear) of the flatbed surface. The invention further comprises storage boxes that open away from the truck and are accessible from the sides and/or rear of the truck.

### BRIEF DESCRIPTION OF THE DRAWINGS

FIG. 1 represents an angled side view of the rectangular flatbed surface, protective guard, compartment assembly and second compartment assembly.

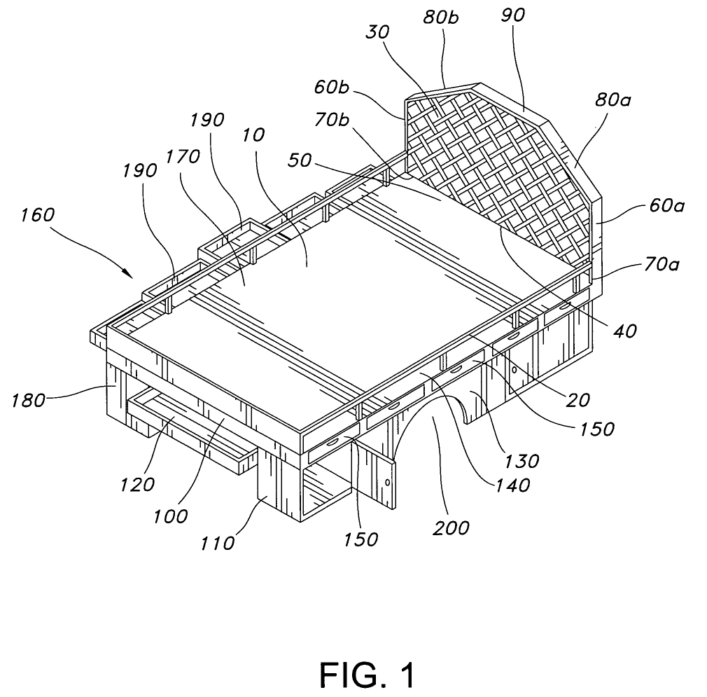

FIG. 2 represents a top view of the rectangular flatbed surface, compartment assembly, second compartment assembly and third compartment assembly.

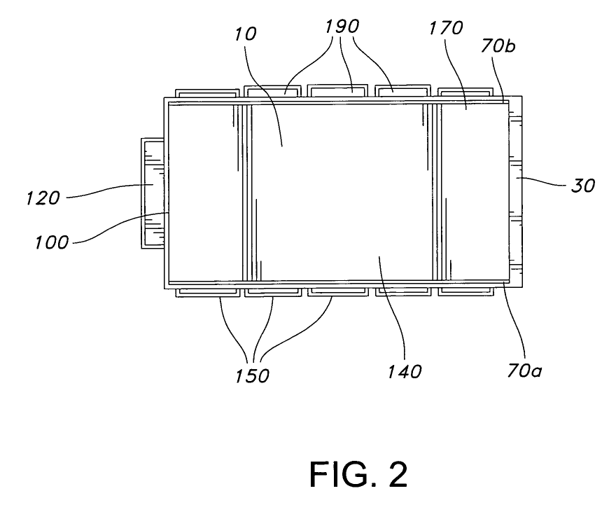

FIG. 3 represents a section view of the rectangular flatbed surface, compartment assembly and second compartment assembly.

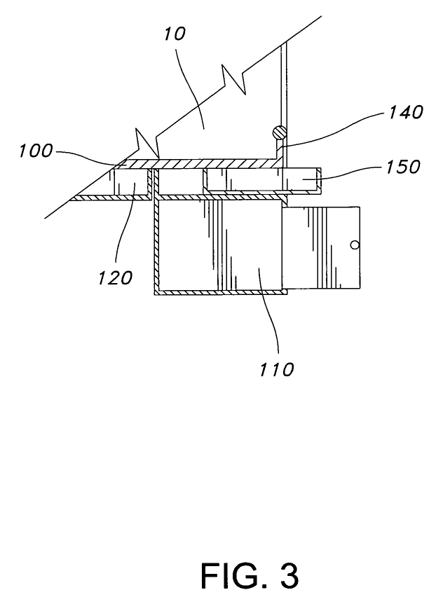

### DETAILED DESCRIPTION OF THE PREFERRED EMBODIMENTS

In the following detailed description of the preferred embodiments, reference is made to the accompanying drawings which form a part hereof, and within which are shown by way of illustration of specific embodiments by which the invention may be practiced. It is to be understood that other embodiments may be utilized and structural changes may be made without departing from the scope of the invention.

Turning now to the drawings wherein like numbers refer to like features throughout the drawings, the present invention comprises a flatbed tool drawer system for mounting on a flatbed truck. Generally speaking, a flatbed truck comprises a cab in which a driver and passengers sit and a large flat surface extending behind the cab and covering, among other things, the drive shaft, rear axle(s) and rear wheels of the truck. A traditional pick-up truck, on the other hand, is generally comprised of a similar configuration but with the addition of solid side walls and a tailgate extending around the periphery of the truck bed. The primary distinction between a traditional pick-up truck and a flatbed truck is that items in the bed of a pick-up truck are contained by the solid side walls, while items on the bed of a flatbed truck are generally not contained by solid side walls.

In one embodiment of the present invention, the flatbed tool drawer system comprises a flatbed surface (10) extending horizontally from behind the cab of a flatbed truck. The flatbed surface is rectangular in shape and approximately as wide as the cab of the truck and long enough to extend over the drive shaft and rear axle(s) of the rear wheels of the truck. The flatbed surface (10) may extend directly over the drive shaft and rear axle(s) or it may extend over an existing flatbed of a flatbed truck. One of ordinary skill in the art will realize that the flatbed surface may be made of any strong material such as steel, other metal, rubber or plastic. The flatbed surface (10) may be smooth or textured depending on whether it is desirable to easily slide items on and off of the flatbed surface (10). The flatbed surface (10) may be bordered along the periphery with rails (20), although such rails are optional.

A protective guard (30) extends vertically upward from the front of the flatbed surface (10) adjacent the cab of the truck. The protective guard (30) protects the rear window of the truck cab. In one embodiment of the invention, the protective guard is partially open to allow the driver of the truck to see through the rear window of the cab. The protective guard (30) extends vertically to the approximate height of roof of the truck cab. The protective guard (30) may be shaped similar to the shape of the rear of the truck cab. In one embodiment of the present invention, the protective guard (30) is six sided, comprised of namely a bottom side (40) extending along the front (50) of the flatbed surface, two opposing vertical sides (60a and 60b) extending vertically upwards from two corners (70a and 70b) of the front (50) of the flatbed surface, two opposing angled sides (80a and 80b) extending at approximately 45 degree angles from the top of the opposing vertical sides (60a and 60b), and a top side (90) connecting the two opposing angled sides (80a and 80b).

The present invention also comprises a compartment assembly (100) extending vertically downward from the rear of the flatbed surface (10). The compartment assembly (100) extends horizontally approximately the width of the flatbed surface (10). The compartment assembly (100) extends vertically downward substantially no lower than the rear bumper of the flatbed truck. The compartment assembly (100) may include a box (110) for storage and, in a preferred embodiment, a drawer (120) opening horizontally away from the rear of the flatbed truck.

The present invention also comprises a second compartment assembly (130) extending vertically downward from a side (140) of the flatbed surface (10). The second compartment assembly (130) extends horizontally along a side (140) of the flatbed surface (10). The second compartment assembly (130) may include a box (110) for storage and, in a preferred embodiment, drawers (150) opening horizontally away from flatbed truck. The box (110) and/or drawers (150) may lock.

The present invention also comprises a third compartment assembly (160) extending vertically downward from a side (170) of the flatbed surface (10). The third compartment assembly (160) extends horizontally along a side (170) of the flatbed surface (10). The third compartment assembly (160) may include a box (180) for storage and, in a preferred embodiment, drawers (190) opening horizontally away from flatbed truck. The box (180) and/or drawers (190) may lock.

In a preferred embodiment, the second (130) and third (160) compartment assemblies extend horizontally substantially the length of opposing sides (140 and 170) of the flatbed surface (10). The second (130) and third (160) compartment assemblies generally extend vertically downward approximately one half of the way down the rear wheel(s). The second (130) and third (160) compartment assemblies may be shaped with wheel wells (200) to cover the rear wheel(s) of the flatbed truck.

One of ordinary skill in the art will realize that due to the rough conditions to which some truck owners expose their trucks, the flatbed tool drawer system of the present invention should be made from rugged material such as metal, for example iron or steel. If the present invention is made of rubber or plastic it should be very durable rubber or plastic. The present invention should be securely attached to the truck by means of bolting the invention to the existing flatbed of a flatbed truck and/or bolting the invention to the frame of the truck. Alternatively, the invention may be welded to the flatbed or frame of the truck.

What is claimed is:

1. A flatbed tool drawer system for mounting on a flatbed truck comprising:
a rectangular flatbed surface extending horizontally from behind the cab of a flatbed truck;
a protective guard extending vertically upward from the front of the flatbed surface;
a compartment assembly extending vertically downward from the rear of the flatbed surface;
a second compartment assembly extending vertically downward from a side of the flatbed surface; and
a third compartment assembly extending vertically downward from an opposing side of the flatbed surface.

2. The flatbed tool drawer system of claim 1, wherein the rectangular flatbed surface is bordered by rails extending vertically along the opposing sides and rear of the flatbed surface.

3. The flatbed tool drawer system of claim 1, wherein the protective guard extends vertically upward a distance sufficient to cover and protect the rear window of a cab of the flatbed truck.

4. The flatbed tool drawer system of claim 3, wherein the protective guard is comprised of six sides, namely a bottom side extending along the front of the flatbed surface, two opposing vertical sides extending vertically upwards from two corners of the front of the flatbed surface, two opposing angled sides extending at approximately 45 degree angles from the top of the opposing vertical sides towards one another, and a top side connecting the two opposing angled sides.

5. The flatbed tool drawer system of claim 1, wherein the compartment assembly extending vertically downward from the rear of the flatbed surface extends horizontally the length of the rear of the flatbed surface and vertically no lower than a bumper of the rear of the flatbed truck.

6. The flatbed tool drawer system of claim 5, wherein the compartment assembly extending vertically downward from the rear of the flatbed surface comprises a drawer opening away from the rear of the flatbed truck.

7. The flatbed tool drawer system of claim 6, wherein the second compartment assembly extending vertically downward from a side of the flatbed surface comprises a drawer opening away from the side of the flatbed truck.

8. The flatbed tool drawer system of claim 7, wherein the third compartment assembly extending vertically downward from a side of the flatbed surface comprises a drawer opening away from the side of the flatbed truck.

9. The flatbed tool drawer system of claim 8, wherein the second and third compartment assemblies extend vertically downward no lower than approximately one halfway down a rear tire of the flatbed truck.

10. The flatbed tool drawer system of claim 9, wherein the second and third compartment assemblies are each further comprised of a wheel well cover.

11. The flatbed tool drawer system of claim 10, wherein the second compartment assembly further comprises a storage box.

12. The flatbed tool drawer system of claim 10, wherein the third compartment assembly further comprises a storage box.

13. The flatbed tool drawer system of claim 11 or 12, wherein the storage box comprises a lockable door opening away from the flatbed truck.

14. The flatbed tool drawer system of claim 1, wherein the system is bolted to the flatbed truck.

15. The flatbed tool drawer system of claim 1, wherein the system is welded to the flatbed truck.

16. The flatbed tool drawer system of claim 1, wherein the system is made of steel.

17. The flatbed tool drawer system of claim 4, wherein a portion of the center of the protective guard is open.
